(19) United States
(12) Patent Application Publication
(10) Pub. No.: US 2009/0212184 A1
(43) Pub. Date: Aug. 27, 2009

(54) Articulated Mounting Systems And Bearings For Joints Thereof

(75) Inventors: Barry K. Bourgeois, Gilbert, AZ (US); James R. Bradbury, Littleton, CO (US); Steven A. Sherwood, Littleton, CO (US)

Correspondence Address: SCHMEISER OLSEN & WATTS, 18 E UNIVERSITY DRIVE, SUITE # 101, MESA, AZ, 85201, US

(73) Assignee: HENSLEY KIM & EDGINGTON, LLC, Denver, CO (US)

(21) Appl. No.: 11/814,481

(22) PCT Filed: Jan. 20, 2006
(86) PCT No.: PCT/US2006/002143

§ 371 Date: Sep. 10, 2008

Related U.S. Application Data
(60) Provisional application No. 60/645,799, filed on Jan. 20, 2005.

(51) Int. Cl. A47F 5/10; G05G 5/06; A47F 5/06

(52) U.S. Cl. 248/288.11; 74/527; 248/295.11

(57) ABSTRACT

An articulated mounting system (100) includes indexed bearings (118) at joints (154, 156, 158) between two members (102a, 102b, 106, 160) that provide stepped rotational movement between the two members (102a, 102b, 106, 160). The indexed bearings (118) are resistant to gravitational slippage. The indexed bearings (118) maintain the position of the joint (154, 156, 158) with tightening the joint (154, 156, 158) and allow for rotational movement of members about the joint (154, 156, 158) without loosening. An adjustable, vertically-oriented, ceiling mount system has leveling mechanism for ensuring that the telescoping tubes are vertically plum. A display mount (300) has handles (310) for allowing adjustment of the position of the mounting system members (102a, 102b, 106, 160) and the angle of display while maintaining a sterile operating field.

### CROSS REFERECE TO RELATED APPLICATIONS

This application claims priority pursuant to 35 U.S.C. §119(e) to U.S. provisional application No. 60/645,799 filed 20 Jan. 2005, which is hereby incorporated by reference herein in its entirety.

### BACKGROUND OF THE INVENTION

1. Field of the Invention

This invention relates to articulated arms for mounting televisions, computer monitors, and other displays to walls, ceilings, and other surfaces.

2. Description of the Related Art

Prior designs of articulated mounting arms for supporting various display devices, for example, televisions, computer monitors, and flat panel displays suffer from several problems that negatively impact the installation efficacy and ease of manipulation when in use. One such problem is gravity drift wherein the force of gravity on the display device and the mounting structure itself causes the position of the display device to move or slip because the joints are unable to withstand the force of gravity. A second problem concerns the difficulty of installation of prior art articulated mounting arms. For example, many prior art designs require any cables or cords to be threaded through the arms and joints before assembly of the arms and joints together, which greatly increases the difficulty of installation. In another particular instance, systems for installing articulated mounting arms from a ceiling are inflexible in that the vertical mounting posts are not variable in height depending on the height of the structural ceiling, for example, above a drop ceiling. In many cases the steel or aluminum tubes used for the vertical support must be physically cut to shorter sizes to fit the installation parameters.

Another problem with prior art articulated mounting arm systems arises specifically in certain installation environments, for example, in dental and medical offices. Once a healthcare provider is sterile, i.e., the provider has donned latex gloves to perform a medical procedure, the provider cannot touch a nonsterile surface. Therefore, if the provider wanted to show the patient information about the procedure being performed, for example, real time video of the procedure or x-rays of teeth, the provider has to deglove to adjust the position of the display and then reglove to reenter the sterile field.

The information included in this Background section of the specification, including any references cited herein and any description or discussion thereof, is included for technical reference purposes only and is not to be regarded subject matter by which the scope of the invention is to be bound.

### SUMMARY OF THE INVENTION

The present disclosure describes several features for use in articulated mounting arm systems. A first of these features is an indexed bearing that is resistant to gravitational drag on the joints of an articulated mounting arm system. A second feature is a telescoping ceiling mount system that allows the height of the vertical ceiling mount tube to be easily adjusted and fixed. A fourth feature is a vertical leveling system for ensuring that a vertical mounting post is plumb. A fifth feature is display mount that provides the ability for the articulated mounting arm system to be manipulated while maintaining a sterile field, for example, during medical or dental procedures. A sixth feature is a cable routing system that allows cables and cords to be routed along and within the arms of an articulated mounting arm system after the mounting arms are assembled and mounted in place.

Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is an isometric view of an articulated mounting system including a display mount for a display device.

FIG. 2 is an exploded view from a top perspective of a portion of the articulated mounting system of FIG. 1.

FIG. 3 is an exploded view from a bottom perspective of a portion of the articulated mounting system of FIG. 1.

FIG. 4 is a top plan view of an index plate in an index bearing indicated in FIG. 1.

FIG. 5 is an isometric view of the index plate of FIG. 4.

FIG. 6 is a top plan view of a bearing plate in the index bearing indicated in FIG. 1.

FIG. 7 is an isometric view of the bearing plate of FIG. 6.

FIG. 8 is a bottom plan view of an arm of the articulated mounting system of FIG. 1.

FIG. 9 is a top isometric view of an arm of the articulated mounting system of FIG. 1.

FIG. 10 is an exploded view of an indexed display bearing with a partial view of a display mount of the articulated mounting system of FIG. 1.

FIG. 11 is a side plan view in partial cross section of the indexed display bearing and display mount of FIG. 10.

FIG. 12 is an isometric view of the display mount of the articulated mounting system of FIG. 1.

FIG. 13 is a rear plan view of the display mount of FIG. 12.

FIG. 14 is an isometric view of a telescoping ceiling mount system.

FIG. 15 is an isometric view of an articulated ceiling mount system.

FIG. 16A is a rear plan view of a hinge cover of the articulated ceiling mount system of FIG. 15.

FIG. 16B is a front plan view of the hinge cover of the articulated ceiling mount system of FIG. 15.

FIG. 16C is a side plan view of the hinge cover of the articulated ceiling mount system of FIG. 15.

FIG. 17A is an isometric view of a gas cylinder channel of an extension arm of the articulated ceiling mount system of FIG. 15.

FIG. 17B is a side plan view of the gas cylinder channel of the extension arm of the articulated ceiling mount system of FIG. 15.

FIG. 18A is an isometric view of a cable cover of an extension arm of the articulated ceiling mount system of FIG. 15.

FIG. 18B is a side plan view of the cable cover of the extension arm of the articulated ceiling mount system of FIG. 15.

FIG. 19A is an isometric view of a pivot arm of an extension arm of the articulated ceiling mount system of FIG. 15.

FIG. 19B is a side plan view of the pivot arm of the extension arm of the articulated ceiling mount system of FIG. 15.

FIG. 19C is a top plan view of the pivot arm of the extension arm of the articulated ceiling mount system of FIG. 15.

FIG. 20 is an isometric view of a hinge unit of the extension arm of the articulated ceiling mount system of FIG. 15.

FIG. 21 is an exploded view from a top perspective of a nested index bearing of the articulated ceiling mount system of FIG. 15.

FIG. 22 is an exploded view from a bottom perspective of the nested index bearing of the articulated ceiling mount system of FIG. 15.

### DETAILED DESCRIPTION OF THE INVENTION

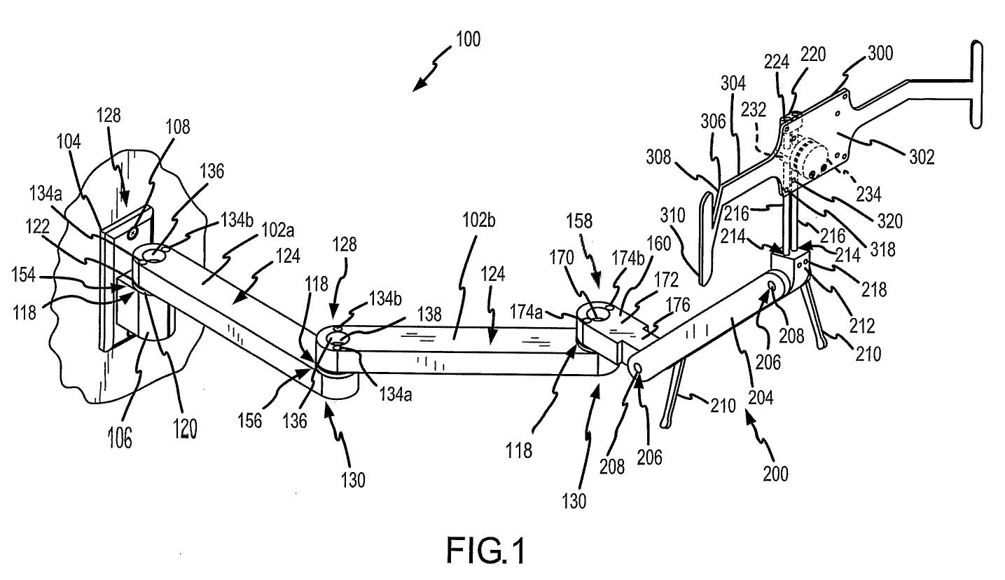

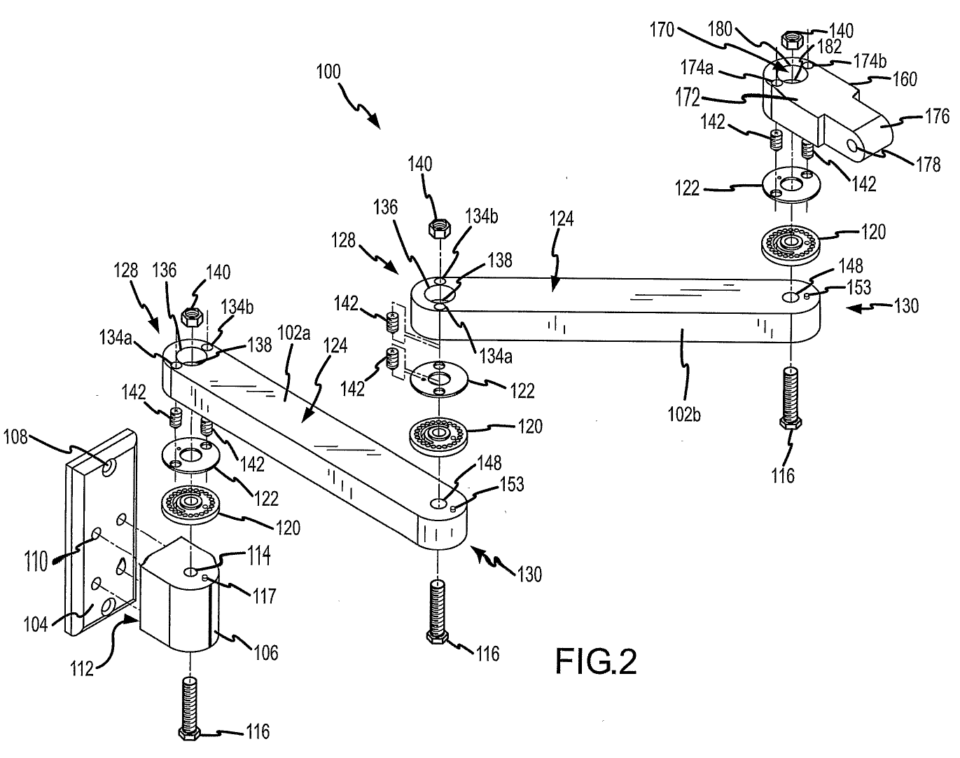

FIGS. 1 and 2 depict an articulated wall mount system 100 for supporting a device, for example, a television, computer monitor, flat panel display, or other video display device, audio or video control system, medical equipment, a task light, or any other piece of equipment. The articulated wall mount system 100 may support additional related items, for example, a computer keyboard tray, computer mouse tray, or other supports for related computer peripheral equipment.

The articulated wall mount system 100 may comprise one or more members extending from and mounted to a wall via a wall bracket 104. The wall bracket 104 may have a number of mounting apertures 108 through its face at both the top and bottom of the wall bracket 104. The mounting apertures 108 are designed to accept fastening devices, for example, lag bolts, which may be used to secure the wall bracket 104 to a vertical surface, for example, a wall or preferably a structural member of the wall, for example, a stud. The wall bracket 104 may be a rectangular metal plate of sufficient size to accommodate the attachment a first member, for example, a bracket post 106. The bracket post 106 is itself of sufficient size to support additional members, for example, one or more arms 102a, 102b, a pivot member 160, and other linkage members of or attached to the articulated wall mount system 100. The major components of the articulated wall mount system 100 may be made of milled aluminum, steel, or other similar material with sufficient material strength to support a display device or other related devices.

The bracket post 106 is joined to the wall bracket 104 via four set screws (not shown), as indicated by the screw apertures 110 in FIG. 2. The set screws extend from the back side of the wall bracket 104 through the screw apertures 110 in the wall bracket 104 and are secured in four corresponding tapped or threaded holes in the flat face 112 of the bracket post 106. The bracket post 106 is of sufficient height to accommodate both the four set screws joining it to the wall bracket 104 and a vertical through-hole 114 to which a first arm 102a of the articulated wall mount system 100 is mounted. The bottom aperture of the through-hole 114 in the bracket post 106 is a semi-blind hole 115, which provides a lip or flange surface for supporting the head of a shoulder bolt 116 that is used to join the bracket post 106 to the first arm 102a at a bracket joint 154. A set pin 117 also protrudes from the top surface of the bracket post 106 distal to the vertical through-hole 114. An index bearing 118 is formed between mounting surfaces, for example the first arm 102a and the bracket post 106. The index beating 118 is primarily comprised of an index plate 120 and a bearing plate 122, which will be described in further detail below.

The first arm 102a and second arm 102b are identical in construction such that they may be freely interchanged. From a manufacturing standpoint, this means that only a single arm design need be manufactured for use in the combination of multiple arms for the articulated wall mount system 100. In one embodiment, each arm 102a, 102b may be approximately one foot long by one inch deep and one and three-quarter inches wide. However, the arms 102a, 102b may be scaled to any length, width, or thickness as desired or necessary for the particular application. Each arm 102a, 102b may have a top face 124 and a bottom face 126 and can be considered to have a proximal end 128 and a distal end 130 with respect to the wall bracket 104, proximal herein meaning closer to the wall bracket 104 in the chain of joints. The top face 124 of the first arm 102a and second arm 102b is shown in FIGS. 1, 2, and 9.

The proximal end 124 of each arm 102a, 102b defines three apertures, a center through-hole 132 and two opposing cartridge cavities 134a, 134b positioned on opposite sides of the center through-hole 132. Circumscribing the center through-hole 132 on the top face 124 of the arms 102a, 102b is a semi-blind hole 136, which provides a lip or flange 138 for fastening a lock nut 140 to a shoulder bolt 116 extending through the center through-hole 132 in the arm 102a, 102b. For example, the shoulder bolt 116 extends through the bracket post 106, the index bearing 118, and the center through-hole 132 of the first arm 102a at the proximal end 128. Washers (not shown) may be inserted over the threaded end of the shoulder bolt 116 and the lock nut 140 secured to the threaded end of the shoulder bolt 16 over the washers thus holds the first arm 102a to the bracket post 106, sandwiching the index bearing 118 between the first arm 102a and the bracket post 106.

Two cartridge cavities 134a, 134b are through-holes formed on either side of the center through-hole 132 at the proximal end 128 of each arm 102a, 102b through the thickness of each arm 102a, 102b. The cartridge cavities 134a, 134b are threaded and each houses an elastic retention structure, for example a spring plunger cartridge 142. The outer surface of the spring plunger cartridge 142 is threaded and acts as a set screw to fix the spring plunger cartridge 142 in the cartridge cavities 134a, 134b.

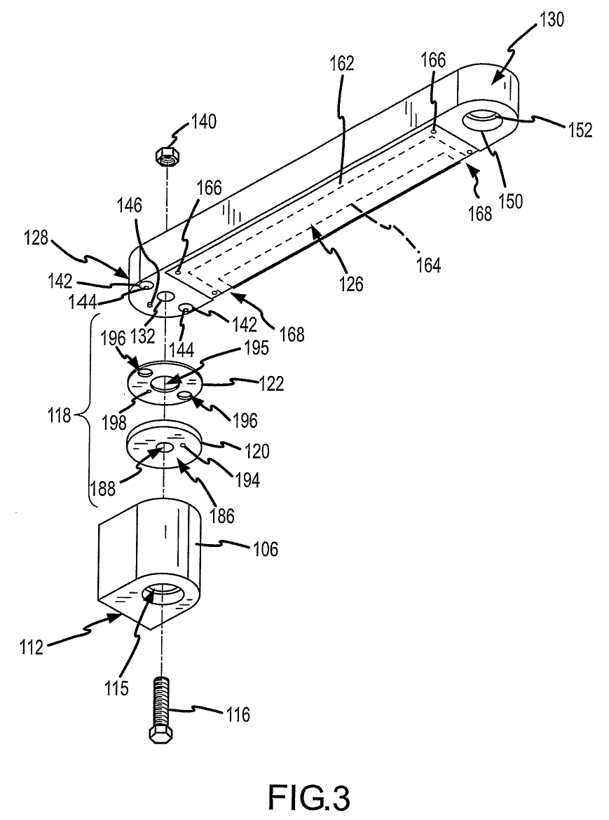

The bottom face 126 of each arm 102a, 102b is depicted in FIGS. 3 and 8. The bottom face 126 at the proximal end 128 of each of the arms 102a, 102b is generally a flat surface that defines the center through-hole 132 and is bounded on opposing sides by the two cartridge cavities 134a, 134b. These are the opposite ends of the center through-hole 132 and cartridge cavities 134a, 134b shown on the top face 124 of each of the arms 102a, 102b, There is no semi-blind hole surrounding center through-hole 132 on the bottom face 126 of the arms 102a, 102b in contrast to the top face 124 of the arms 102a, 102b.

The spring plunger cartridges 142 protrude through the cartridge cavities 134a, 134b and extend slightly beyond the bottom face 126 of each arm 102a, 102b. A ball nose 144 protrudes slightly beyond the spring plunger cartridge 142. An engagement structure, e.g., a set pin 146, may also protrude from the bottom face 130 of each arm 102a, 102b at the proximal end 124 adjacent to the center through-hole 132. The function of the elastic retention structures and the engagement structures will be described in greater detail further herein.

The distal end 130 of each arm 102a, 102b defines a center through-hole 148 similar to that previously described with respect to the proximal end 128 of each arm 102a, 102b. The center through-hole 148 opening in the bottom face 126 at the distal end 130 of each arm 102a, 102b is circumscribed by a semi-blind hole 150. The semi-blind hole 150 provides a flange 152 or shoulder to interface with a washer (not shown) and the head of a shoulder bolt 116 for joining each of the arms 102a, 102b together at an arm joint 156 or joining an arm 102b to a pivot mount 160 at a pivot joint 158. The shoulder bolt 116 extends through an index plate 120 and bearing plate 122 mounted on the top face 124 at the distal end 130 of each arm 102a, 102b. A set pin 153 also protrudes from the top face 124 of the distal end 130 of each arm 102a, 102b adjacent the center through-hole 148. The set pin 153 interfaces with a set pin hole 194 in the index plate 120, as shown in FIGS. 2 and 3. The index plate 120 is thus held in place at the distal end 130 of each arm 102a, 102b as the set pin 153, in conjunction with the shoulder bolt 116, prevents rotation of the index plate 120 with respect to each arm 102a, 102b.

A cord channel 162 is defined within the bottom face 126 of each arm 102a, 102b and is positioned between proximal end 128 and the distal end 130 of each arm 102a, 102b. The cord channel 162 secures any power or data cables or cords routed to the display device mounted at the distal end of the articulated wall mount system 100. The cord channel 162 is covered by a channel cover 164 that is held in place by a plurality of cover set screws 166. A pair of cord ports 168 is formed in the side wall of each of the arms 102a, 102b and allow the cables or cords to enter and exit the cord channel 162 at points adjacent the proximal end 128 and distal end 130 of each of the arms 102a, 102b. The channel cover 164 allows for easy removal and placement of cords or cables within the cord channel 162. By securely fastening the channel cover 164 to each arm a length of cable is hidden cleanly within each arm 102a, 102b. The cord ports 168 allow the cords or cables to easily exit the cord channels 162 for routing around each of the joints 154, 156, 158 of the articulated wall mount system 100.

A bidirectional pivot member 160 is shown in FIGS. 1 and 2 both attached and detached from the pivot joint 158 at the distal end 130 of the second arm 102b. The bottom surface of the bidirectional pivot member 160 is mated with the top face 124 of the distal end 130 of the second arm 102b and placed on top of the bearing plate 122 and index plate 120 positioned therebetween. A vertical through-hole 170 in the horizontal pivot section 172 of the bidirectional pivot member 160 is aligned with the center through-hole 148 in the distal end 130 of the second arm 102b. Surrounding the vertical through-hole 148 is a semi-blind hole 180, which forms a recessed ledge 182 around the vertical through-hole 148 for interfacing with a washer and lock nut 140 on a shoulder bolt 116 that joins the bidirectional pivot member 160 and the distal end 130 of the second arm 102b to create the pivot joint 158.

Also shown on the top surface of the bidirectional pivot member 160 is a pair of cartridge cavities 174a, 174b with cartridge set screws holding the spring ball cartridges in place within the cartridge cavities. Similar to the prior description with respect to the bottom faces 126 of the proximal ends 130 of each of the arms 102a, 102b, the cartridge cavities 174a, 174b house spring plunger cartridges 142, each with a ball nose 144 that extends beyond the bottom surface of the horizontal pivot section 172 on opposing sides of the vertical through-hole 170. In addition, a set pin (not shown) extends from bottom surface of the horizontal pivot section 172 adjacent to the vertical through-hole 170.

Extending laterally from the horizontal pivot section 172 of the bidirectional pivot member 160 is a vertical pivot section 176. A horizontal through-hole 178 is formed within a portion of the vertical pivot section 176 as indicated in FIG. 2. The horizontal through-hole 178 accepts additional components for the mounting of a display device, which additional components will be described in greater detail further herein.

The articulated wall mount system 100 as depicted in FIGS. 1-3 is composed of three primary joints: the bracket joint 154, the arm joint 156, and the pivot joint 158. Each of these joints allows for rotational movement of each of the arms 102a, 102b or of the bidirectional pivot member 160 about a central pivot point in each of the joints. This rotational movement may be indexed or incrementally stepped by the index bearing 118. An identical index bearing 118 forms each of the bracket joint 154, the arm joint 156, and the pivot joint 158. Each of the index bearings 118 is formed by the combination of and interface between the bearing plate 122, the index plate 120, and the spring plunger cartridges 142, which are held together through the center through-holes 132, 148, 170 by shoulder bolts 116, washers, and lock nuts 140.

The index plate 120 and the bearing plate 122 are depicted in greater detail in FIGS. 3-7. The index plate 120 is depicted in particular detail in FIGS. 3-5. The index plate 120 is a circular disk bearing member with a top surface 184 and a bottom surface 196 and defines a center through-hole 188 at the center of the disk. A disk rim 190 extends above the top surface 184 of the index plate 120 and surrounds the center through-hole 188 to form an annular raised ring.

An array of detent structures, for example, dimples 192, is formed in the top surface 184 of the index plate 120 in a circular pattern adjacent the outer circumference of the index plate 120. The detent dimples 192 are of a diameter and depth selected to interface with the exposed height of each of the ball noses 144 of the spring plunger cartridges 142. Also, each of the spring plunger cartridges 142 mounted in the arms 102a, 102b and in the bidirectional pivot member 160 is separated from its pair the same distance as the diameter of the circle formed through the centers of the detent dimples 192, thus allowing the ball noses 144 to rest within the detent dimples 192. When a member is rotated about a joint, the ball noses 144 are pushed into the spring plunger cartridges 142 as the ball noses 144 are forced out of a pair of detent dimples 192 and onto the higher, flat top surface 184 of the index plate 120. As the joint rotates, the ball noses 144 are pushed into the next incremental pair of detent dimples 192 by an opposing spring in the spring plunger cartridges 142, thus pausing the rotation of the joint in the next indexed position.

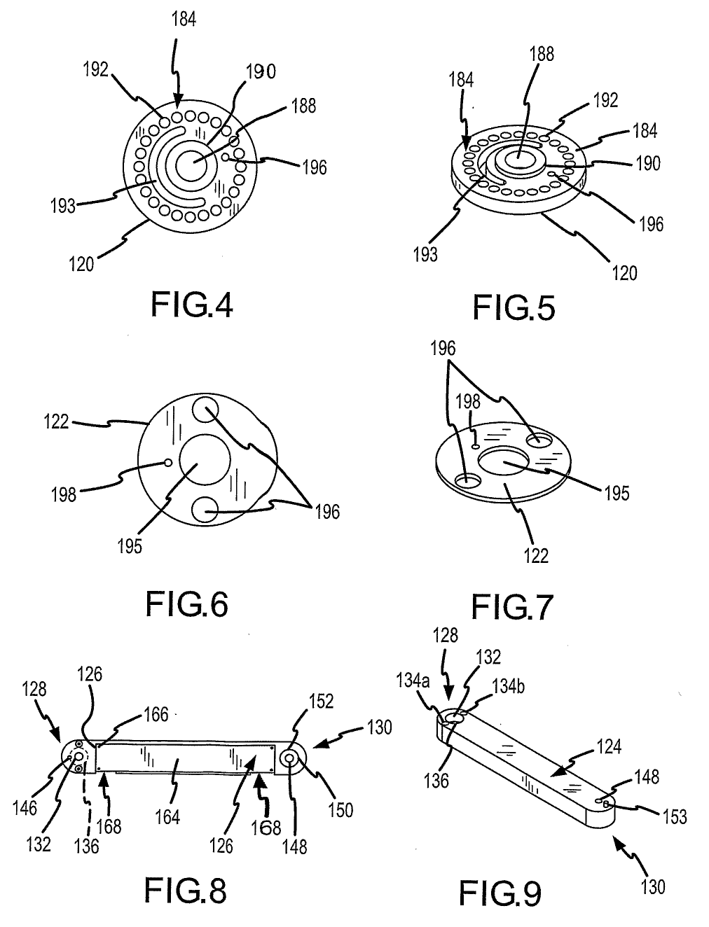

The top surface 184 of the index plate 120 may also define a rotation limitation structure, for example, an arcuate groove 193, positioned between the array of detent dimples 192 and the disk rim 190 surrounding the center through-hole 188. The arcuate groove 193 may be any desired arc length between approximately 0° and 360°. The purpose of the arcuate groove 193 is to limit the range of rotational movement provided by the index bearing 118. As depicted in FIGS. 4 and 5, the arcuate groove 193 may be between 180° and 200° allowing for a half-circular range of rotational movement between each of the arms 102a, 102b and the bidirectional pivot member 160 affixed thereto.

The index plate 120 also defines a through-hole 194 positioned between the disk rim 190 and the detent dimples 192 and spaced apart from the arcuate groove 193. The through-hole 194 is provided for the acceptance of the set pins 117, 153 protruding from the top surface of the bracket post 106 or the top surface 124 of the arms 102, 102b. The through-hole 194 is positioned with respect to the arcuate groove 193 and with respect to the position of the set pins 117, 153 in order to appropriately position the arcuate groove 193 with respect to the joints 154, 156, 158 and thus set the start and stop points of the rotational movement of each member extending from the joint.

For example, in FIGS. 4 and 5, the arcuate groove 193 extends from one lateral side to the other lateral side of the bracket post 106 and arms 102a, 102b and the apex of the arc is oriented toward the proximal ends 124 of the arms 102a, 102b. As will be explained further below, this orientation of the index plate 120 allows an attached arm 102a, 102b or bidirectional pivot member 160 attached at the respective joint 154, 156, 158 to rotate 180° from a point perpendicular on one lateral side of the bracket post 106 or proximal arm 102a to a position perpendicular to the opposing lateral side of the bracket post 106 or proximal arm 102a.

The bearing plate 122 may be a disk of machineable plastic with a low coefficient of friction. The bearing plate 122 defines a center through-hole 195 bounded by a pair of opposing ball apertures 196. A set pin hole 198 is also formed in the bearing plate 122 on one side of the center through-hole 195 between each of the ball apertures 196. The diameter of the center through-hole 195 is sized to circumscribe the outer diameter of the disk rim 190 extending from the index plate 120 and fits thereabout. The ball apertures 196 and the bearing plate 122 are sized and positioned to circumscribe each of the ball noses 144 protruding from the bottom surface 126 of either of the arms 102a, 102b or of the bottom surface of the bidirectional pivot member 160.

The engagement structure, i.e., the set pin 146 protruding from the bottom surface of the proximal end 128 of each arm 102a, 102b or from the bottom surface of the bidirectional pivot member 160, extends through the set pin hole 198 in the bearing plate 122 and interfaces with the arcuate groove 193 in the index plate 120. The arc length of the arcuate groove 193 in the index plate 120 thus limits the range of motion of each joint 154, 156, 158, for example, between each of the arms 102a, 102b about the arm joint 156. For example, if the arc length of the arcuate groove 193 is 180°, each of the arms 102a, 102b will be able to rotate about the arm joint 156 only 180° with respect to each other.

The degree of rotation can be changed by shortening or lengthening the arc length of the arcuate groove 193. Alternatively, if a full range of rotation is desired, the index plate 120 can be made without including the arcuate groove 193, the set pin 146 can be removed, or the height of the set pin 126 can be reduced such that it does not extend beyond the thickness of the bearing plate 122. Alternatively, the set pin 146 can remain unchanged in length and the arcuate groove 193 could extend entirely around the perimeter of the disk rim 190. In another embodiment, any index plate 120 with an arcuate groove 193 of any length can be turned into a fully rotational joint by merely trimming the height of the set pin 146 such that it does not extend beyond the thickness of the bearing plate 122.

The index bearing 118 provides indexed or stepped rotation between members of the articulated wall mount system 100 as the ball noses 144 extending from the spring plunger cartridges 142 fit in the detent dimples 192 as a joint is rotated, thus resulting in a stepped or indexed rather than a fluid rotation. This is advantageous because the index bearing 118 opposes the force of gravity, which can cause drift in prior art joints. Specifically, prior art joints are subject to slippage because of the force of gravity on the mass of the arms and the display devices or other components attached to the arms of those prior art mounting systems. In the present implementation, the force of the spring plunger cartridges 142 is selected such that the interface between the ball noses 144 and the detent dimples 192 in the index plate 120 adequately resist the force of gravity while still allowing for easy rotation of a joint upon exertion of minimal rotational force by a user.

FIGS. 1, 10, and 11 depict a display mount linkage 200 incorporating an indexed display bearing 202. A bidirectional pivot member 160 as previously described may form the proximal component of the display mount linkage 200. The bidirectional pivot member 160 may be coupled with the articulated mounting arm system 100 previously described or any other mounting structure designed to interface with the bidirectional pivot member 160. A pair of angular adjustment bars 204 is coupled with and extends distally from opposing sides of the vertical pivot section 176 of the bidirectional pivot member 160. Each of the angular adjustment bars 204 has a bolt hole 206 defined in both its proximal and distal ends. The bolt holes 206 in the proximal ends of the angular adjustment bars 204 align with the horizontal through-hole 178 in the vertical pivot section 176. A compression bolt 208 is placed through the bolt holes 206 and the horizontal through-hole 178 to couple the bidirectional pivot member 160 and the angular adjustment bars 204. An adjustment handle 210 is mounted on one end of the compression bolt 208, which allows for easy loosening or tightening of the compression bolt 208. The compression bolt 208 provides a hinge that allows the to allow the angular adjustment bars 204 to rotate about the vertical pivot section 176 or alternatively fixes the angular adjustment bars 204 at a particular angle with respect to the bidirectional pivot member 160 by operation of the adjustment handle 210.

The distal ends of the angular adjustment bars 204 extend along opposing sides of a transition block 212. The proximal end of the transition block 212 defines a horizontal through-hole (not visible) that is aligned with the bolt holes 206 in the distal ends of the angular adjustment bars 204. A compression bolt 208 is inserted through the bolt holes 206 in the angular adjustment bars 204 and the through-hole in the transition block 212 thus coupling the transition block 212 to the angular adjustment bars 204. An adjustment handle 210 is mounted on one end of the compression bolt 208, which allows for easy loosening or tightening of the compression bolt 208. The compression bolt 208 provides a hinge that allows the transition block 212 to rotate between the angular adjustment bars 204 and alternatively fixes the transition block 212 at a particular angle between the angular adjustment bars 204 by operation of the adjustment handle 210.

The distal face of the transition block 212 defines two rod cavities 214 Which accept the proximal ends of two slip rods 216 that are inserted therein. The slip rods 216 are held in place in the rod cavities 214 by set screws inserted into set screw cavities 218 on an adjacent side of the transition block 212. The set screw cavities 218 extend through the transition block 212 into the rod cavities 214 thereby allowing the set screws to tighten against the slip rods 216 in the rod cavities 214.

The slip rods 216 extend distally from the transition block 212 in parallel and are held together at their distal end by a rod cap 220. The rod cap 220 defines two semi-blind holes 222 within which the slip rods 216 are inserted. The rod cap 220 in combination with the transition block 212 maintain the parallel position of the slip rods 216. The distal face of the rod cap 220 defines two set screw cavities 224 that adjoin the semi-blind holes 222 in the rod cap 220. A set screw is screwed into a distal end of each slip rod 216 and thereby fastens the rod cap 220 to each of the slip rods 216.

Positioned along the slip rods 216, between the transition block 212 and the rod cap 220, is an indexed display bearing 202 as shown in FIGS. 1, 10 and 11. The indexed display beating 202 defines a pair of rod sleeves 224 extending therethrough. The slip rods 216 pass through a respective rod sleeve 224. One end of the indexed display bearing 202 adjacent the slip rods 216 defines a compression fitting aperture 226. The compression fitting aperture 226 allows a winged bolt 228 to be tightened within the indexed display bearing 202 to force a compression fitting 230 against the slip rods 216 within the indexed display bearing 202, thereby fixing the position of the indexed display bearing 202 at any desired position along the length of the slip rods 216.

The indexed display bearing 202 is composed of four main components: a mounting cap 232, a mounting plate 234, a bearing plate 122, and an index plate 120. The bearing plate 122 and the index plate 120 are identical to the bearing plate 122 and index plate 120 previously described with respect to FIGS. 1-7. The index plate 120 and bearing plate 122 together form an index bearing 118 that is sandwiched in between the mounting plate 234 and the mounting cap 232. The mounting plate 234 is fastened to a display mount 300, while the mounting cap 232 interfaces with the slip rods 216 as previously described.

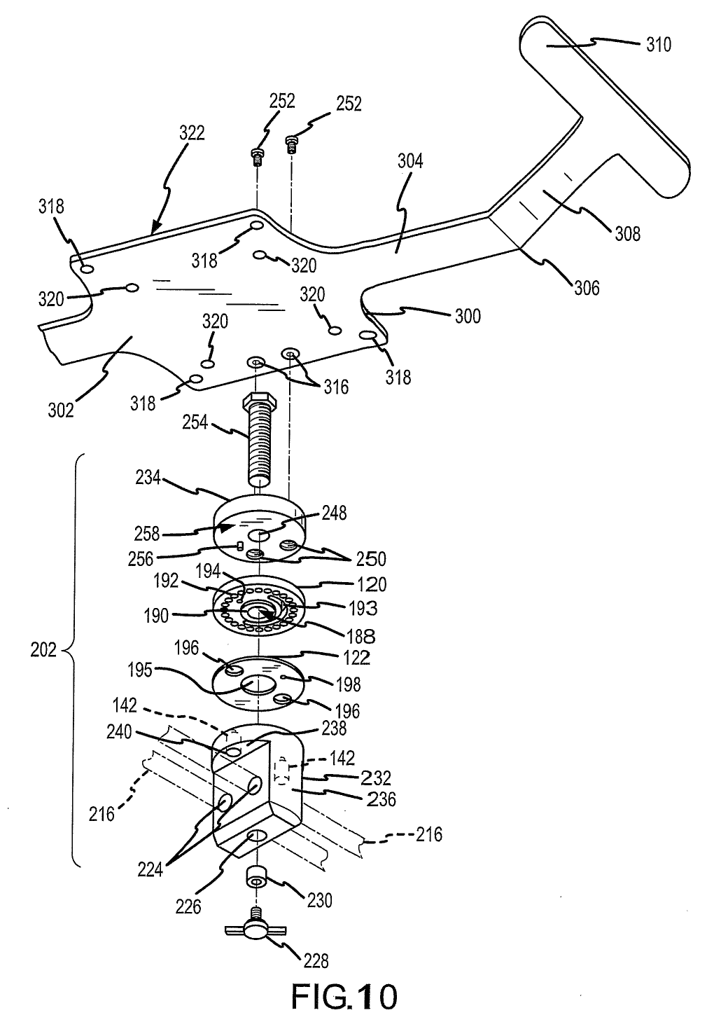

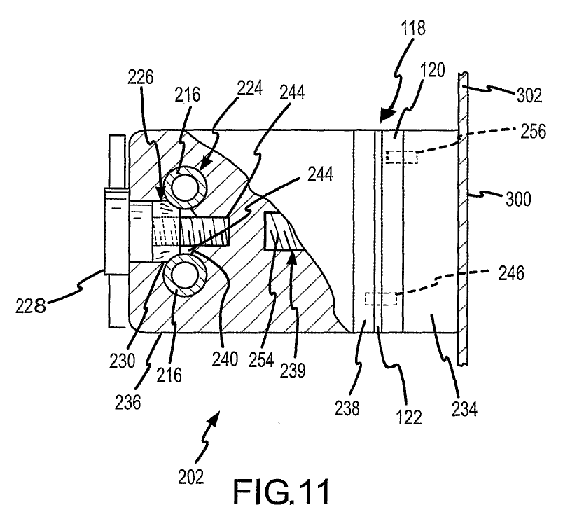

The mounting cap 232 is shown in detail in FIGS. 10 and 11. The mounting cap 232 can be viewed as having two primary sections, a turret 236 and a flange 238. The turret 236 sits on top of the flange 238 and defines the two rod sleeves 224 as well as the compression fitting aperture 226 in the top of the turret 236. Each of the slip rods 216 extends through a respective rod sleeve 224 in the turret 236 of the mounting cap 232.

As best seen in FIG. 11, the compression fitting aperture 226 exposes a compression bar 240 at its base with a bore hole 242 defined therein. The compression bar 240 is narrower than the diameter of the compression fitting aperture 226 and is positioned between the rod sleeves 224. The compression fitting aperture 226 is open to the rod sleeves 224 on either side of compression bar 240 and this opening or space between the compression bar 240 and the wall of the compression fitting aperture 226 provides a rod interface cavity 244. A winged compression bolt 228 is fastened to the bore hole 242 in the compression bar 240. A compression fitting 246 is placed around the winged compression bolt 228, fits within the compression fitting aperture 226, and impinges against the slip rods 216 in the rod interface cavity 244. When the winged compression bolt 228 is rotated to advance the winged compression bolt 228 within the compression bar 240, the compression fitting 246 is forced against each of the slip rods 216, thereby holding the slip rods 216 in place and preventing the mounting cap 232 from sliding along the slip rods 216.

The mounting cap 232 also defines the flange portion 238 that extends at the bottom of the mounting cap 232 on either side of the turret 236. A blind, threaded, bolt hole 239 is defined in the center of the bottom face of the mounting cap 232 and extends through the flange 238 into the turret 236. The bolt hole 239 accepts a bolt 254 to attach the mounting cap 232 to the mounting plate 234 as further described below.

Each side of the flange 238 on opposite sides of the bolt hole 239 defines a cartridge cavity 240 which receives a spring plunger cartridge 142. As when used in conjunction with the articulated wall mount system 100, the spring plunger cartridges 142 are screwed inside the cartridge cavities 240 such that a ball nose 144 protrudes beyond the bottom surface of the mounting cap 232 to extend through the ball apertures 196 in the bearing plate 122 and thus interface with the detent dimples 192 in the index plate 120. The bottom of the mounting cap 232 also has a set pin hole which receives the set pin 246 that extends through the bearing plate 122. In an embodiment wherein limited rotation of the index display bearing 202 is desired, the set pin 246 protruding from the mounting cap 232 may pass through the set pin hole 198 in the bearing plate 122 and interface with the arcuate groove 193 in the index plate 120.

The mounting bearing 234 in FIGS. 10 and 11 is in the form of a disk with a center through-hole 248 and two bore holes 250 offset from the center through-hole 248. The bore holes 250 are threaded to accept set screws 252 for mounting the mounting plate 234 to a display mount 300, which is described in greater detail further herein. A semi-blind hole (not visible) concentric with and circumscribing the center through-hole 248 is defined on the bottom side of the mounting plate 234. The semi-blind hole allows the head of a shoulder bolt 254 extending through the center through-hole 248 to be recessed within the mounting plate 234. The mounting plate 234 additionally has a set pin hole for receiving a set pin 256 that extends from the top side 258 of the mounting plate 234 and interfaces with a similar set pin hole 190 in the index plate 120. Thus, through the cooperation of the shoulder bolt 254 and the set pin 256, the index plate 120 is prevented from rotating with respect to the mounting plate 234.

The indexed display bearing 202 is assembled as shown in FIG. 11 before the mounting plate 234 is attached to the display mount 300. The indexed display bearing 202 is assembled by sandwiching the bearing plate 122 and the index plate 120 between the mounting plate 234 and the mounting cap 232. The threaded bore hole 239 in the bottom of the mounting cap 232 receives the shoulder bolt 254, which is tightened into the mounting cap 232 to hold the components of the index display bearing 202 together, thus forming an index bearing 118. Once the indexed display bearing 202 has been assembled, the indexed display bearing 202 can be fastened to the display mount 300. The mounting plate 234 is mounted to the display mount 300 via two set screws 252 that pass through two mounting holes 316 in the display mount 300 that are also aligned with the pair of threaded bore holes 250 in the mounting plate 232 that receive the set screws 252.

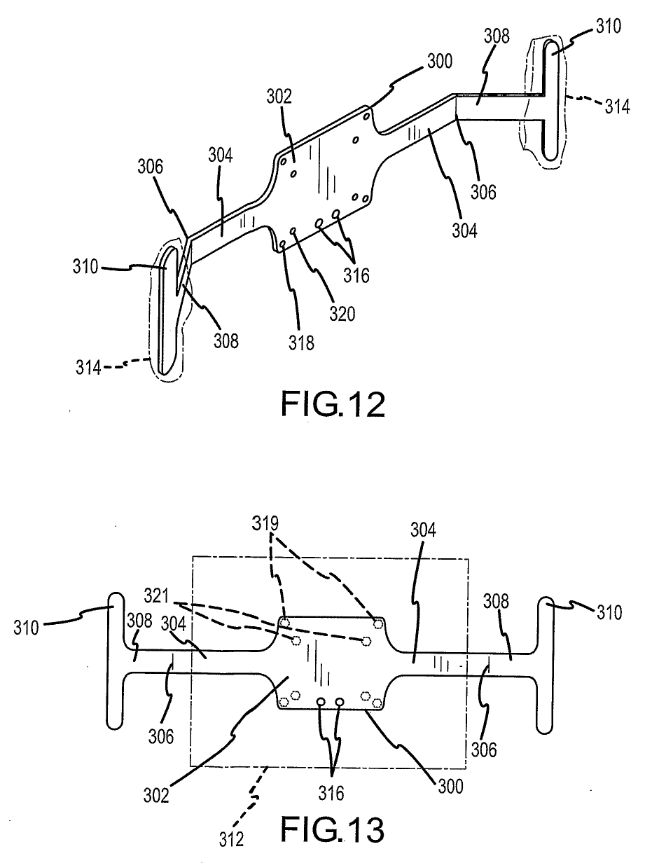

The display mount 300 is depicted in greater detail in FIGS. 12 and 13. The display mount 300 is defined by a center mounting panel 302 which is generally a square-shaped plate. Two lateral arms 304 extend from each side of the mounting panel 302 a distance wider than the width of a display to be mounted on display mount 300. Each lateral arm 304 may be bent forward at an elbow 306 and may extend forward through a wing section 308. The wing section 308 then transitions into a vertically oriented handle 310 that extends above and below the width of the wing 308. Each of the handles 310 thus extends forward beyond the depth of a display device 312 mounted to the front face 322 of the display mount 300 and extends beyond each lateral side of a mounted display device 312. This allows a user to easily grasp a handle 310 and manipulate the position of the display device 312 into any desired location.

The handles 310 may also be covered with a disposable plastic bag 314 or other sterile covering to provide a user in a sterile environment the ability to reposition the display mount 300, and thus the display mount linkage 200, and further any component section of the articulated wall mount system 100 attached thereto, without compromising the sterile field. For example, in a dental office, a dental practitioner who is wearing sterile gloves may manipulate the handle 310 of the display mount 300 covered with a sterile bag 314 and not contaminate the field of operation by doing so.

The mounting panel 302 of the display mount 300 is generally square in shape and defines a number of apertures. Two of the apertures are the mounting holes 316 previously described, which allow a pair of set screws 252 to secure the display mount 300 to the mounting plate 234 as previously described. Additionally there are two sets of four apertures: a set of four outer display mount apertures 318 and a set of four inner display mount apertures 320. Each set of display mount apertures 318, 320 is arranged in a square. The outer display mount apertures 318 may define a square of 100 mm per side. The inner display mount apertures 320 may define a square of 75 mm per side. These are standard measurements for use in mounting flat panel displays according to the guidelines of the Video Electronic Standards Association (VESA). Flat panel displays can thus be mounted to the display mount 300 either via four set screws 319 or other fastening members placed through the set of outer display mount apertures 318 or four set screws 321 or other fastening members placed through the set of inner display mount apertures 320 depending upon the location of receiving holes in the back of the particular flat panel display device 312. Alternately, mounting apertures may be placed at other locations on the mounting panel 302 to accommodate the attachment of other devices with alternate mounting configurations.

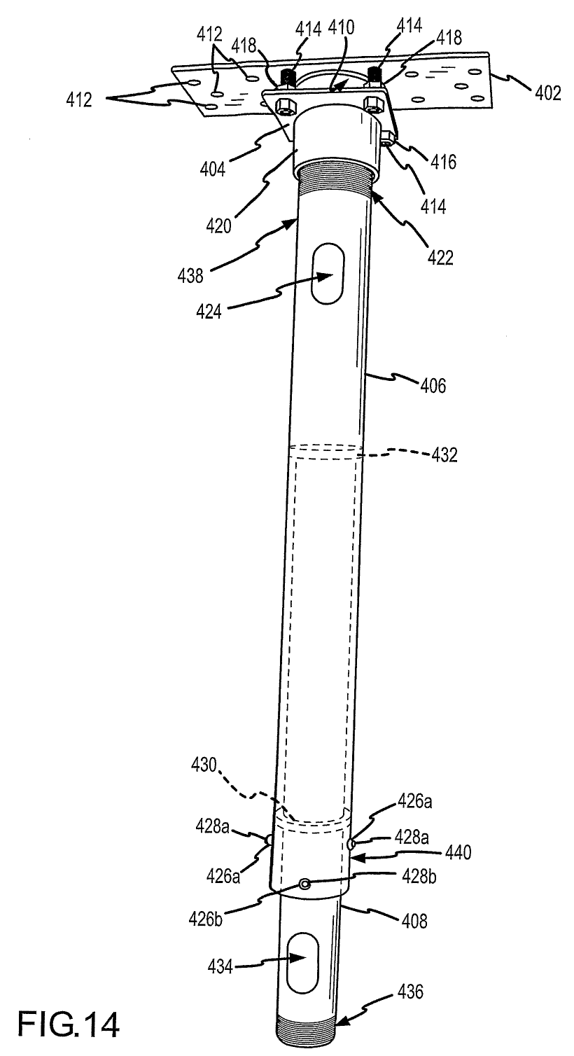

FIG. 14 depicts a telescoping ceiling mount system 400 according to another implementation of the present invention. The telescoping ceiling mount system 400 is composed primarily of a ceiling plate 402, an offset plate 404, an outer tube 406, and an inner tube 408. The ceiling plate 402 may be rectangular in form and may define a large tube aperture 410 centered in the ceiling plate 402. On either side of the tube aperture 410 are a plurality of mounting apertures 412 through which bolts or screws may be inserted to fix the ceiling plate 402 to a mounting surface, such as the ceiling.

The offset plate 404 is connected to the ceiling plate 402 via four leveling bolts 414, although, greater or fewer (e.g., three) bolts could be used. The leveling bolts 414 are permanently affixed to the ceiling plate 402, for example, by welding. The offset plate 404 as depicted is square and the length of its sides is the same as the width of the ceiling plate 402. The four leveling bolts 414 couple with the offset plate 404 through respective apertures in each of the corners of the offset plate 404. A securing nut 416 is fastened to the leveling bolts 414 on the bottom side of the offset plate 404 to couple the offset plate 404 to the leveling bolts 414.

A leveling nut 418 is positioned about each leveling bolt 414 between the offset plate 404 and the ceiling plate 402. By manipulation of the position of the leveling nuts 418 along the leveling bolts 414, the outer tube 406 and the inner tube 408 of the telescoping ceiling mount system 400 may be oriented to be vertically level or plum regardless of whether the ceiling is level. A vertical plum measurement is taken when the offset plate 404 is positioned firmly against the leveling nuts 418. Once the leveling nuts 418 are positioned appropriately such that the outer tube 406 is vertically level or plum, the securing nuts 416 may be tightened against the offset plate 404 to tighten the offset plate 404 against the leveling nuts 418, and thus secure the offset plate 404 in a vertically level position.

A ceiling coupling 420 is affixed to the offset plate 404, for example, by welding. The ceiling coupling 420 may be a hollow cylinder or tube projecting downward from the offset plate 404. The offset plate 404 defines a center aperture (not visible) of a diameter coinciding with the inner diameter of the ceiling coupling 420. The inner wall of the ceiling coupling 420 is threaded for acceptance of and mating with the top end 438 of the outer tube 406. The top end 438 of the outer tube 406 is similarly threaded 422 to mate with the interior threading of the ceiling coupling 420. The outer tube 406 is thus secured to the ceiling coupling 400 by screwing the outer tube 406 into the ceiling coupling 420.

The outer tube 406 may be cylindrical with a sidewall defining a hollow bore the length of the outer tube 406. Adjacent the top end 438 of the outer tube 406 is a cable port 424 which allows cords or cabling for a display panel or other device to be threaded through the outer tube 406. The lower end 440 of the outer tube 406 defines two pairs of apertures 426a, 426b in the sidewall offset both vertically and circumferentially. The upper pair of apertures 426a holds a pair of upper adjustment screws 428a while the lower pair of apertures 426b hold a pair of lower adjustment screws 428b. Above the upper adjustment screws 428a, inside the outer tube 406, a first retention ring 430 is affixed to the interior wall of the outer tube 408. The first retention ring 430 reduces the inner diameter of the outer tube 406 for a short section immediately above the upper adjustment screws 428a.

The inner tube 406 may be cylindrical with a sidewall defining a hollow bore the length of the inner tube 406. The inner tube 408 resides within the outer tube 406 and may be positioned such that a variable length of the inner tube 408 can extend below the outer tube 406 in a telescoping manner. When a desired length of the inner tube 408 extends beneath the outer tube 406, the upper adjustment screws 428a and lower adjustment screws 428b can be advanced through the wall of the outer tube 406 like set screws and press against the outer wall of the inner tube 408 and thus hold the inner tube 408 in place. By offsetting the upper adjustment screws 428a and lower adjustment screws 428b both vertically and circumferentially, an even distribution of pressure is placed on the inner tube 408 to effectively secure its position.

Note that the outer tube 406, the inner tube 408, and the ceiling coupling 420 need not be cylindrical, but can instead be of any cross section, for example, triangular, square, rectangular, hexagonal, oval or otherwise. However, if the outer tube 406, inner tube 408, and ceiling coupling 420 are other than cylindrical, an attachment structure other than threading as previously described may be in order to attach these members to each other or other structures.

The top end of the inner tube 408 is bounded by a second retention ring 432, which is affixed circumferentially about the outer wall of the inner tube 408. This second retention ring 432 increases the diameter of a short section of the inner tube 408. When assembling the telescoping ceiling mount system 400, the inner tube 408 is inserted into the outer tube 406 through the tube aperture 410 in the ceiling plate 402 and through the center aperture in the offset plate 404. If the inner tube 408 were allowed to extend to its greatest length below the outer tube 408, the second retention ring 432 about the inner tube 408 would interface with the first retention ring 430 within the outer tube 406 thus preventing the inner tube 408 from falling out of the outer tube 406. Thus, the only way for the inner tube 408 to be inserted within the outer tube 406 is from the top end 438 of the outer tube 406, which is why the ceiling plate 402 and the offset plate 404 are provided with the tube aperture 410 and center aperture, respectively.

The inner tube 408 also defines a cable port 434 offset from the bottom of the inner tube 408. The outside circumference of a short length of the bottom of the inner tube 408 is threaded 436 in order to allow the inner tube 408 to interface with an articulated ceiling mount system 500 described later herein. The length of the inner tube 408 and the outer tube 406 may vary depending upon maximum and minimum heights needed to extend the telescoping ceiling mount system 400 an adequate distance from the ceiling surface.

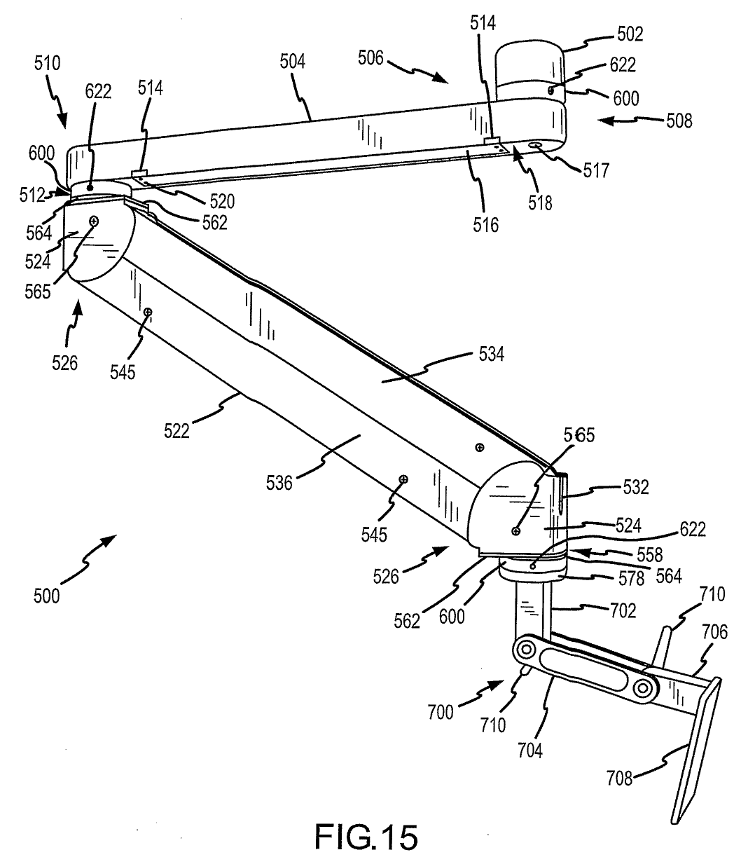

An exemplary articulated ceiling mount system 500 is depicted in FIGS. 15-22. The articulated ceiling mount system 500 may be attached to any appropriate vertical post mount extending from a ceiling. In particular, the articulated ceiling mount system 500 may be coupled with the inner tube 408 extending downward from the telescoping ceiling mount system 400 depicted in FIG. 14 herein. The articulated ceiling mount system 500 first comprises a tube coupling 502 coupled with a horizontal arm 504 via a ceiling joint 506. The interior wall (not visible) of the ceiling coupling 502 is threaded to interface with the threading 436 on the bottom end of the inner tube 408 of the telescoping ceiling mount system 400.

The horizontal arm 504 is a long support member that is cantilevered from the tube coupling 502 at its proximal end 508 along its length to its distal end 510. The horizontal arm 504 defines a cable channel (not visible) therein running the length of the horizontal arm 504 between the ceiling joint 506 of the proximal end 508 and an elbow joint 512 at the distal end 510. One side wall of the horizontal arm 504 defines a pair of cable ports 514, each positioned adjacent and interior to each of the ceiling joint 506 and elbow joint, 512. An access panel 516 is provided on the bottom face 518 of the horizontal arm 504 to cover the cable channel (not visible) defined therein. The access panel 516 may be attached to mounting points along the bottom face 518 of the horizontal arm 504 by a number of set screws 520.

The distal end 510 of the horizontal arm 504 is coupled with an extension arm 522 via the elbow joint 512. The extension arm 522 is a member that angles downward from the distal end 510 of the horizontal arm 504. A hinge cover 524 caps each end of the extension arm 522. In the present design, the hinge covers 524 for each end of the extension arm 522 are the same design and interchangeable. The extension arm 522 interfaces with the hinge covers 524 to create a hinge joint 526 therewith.

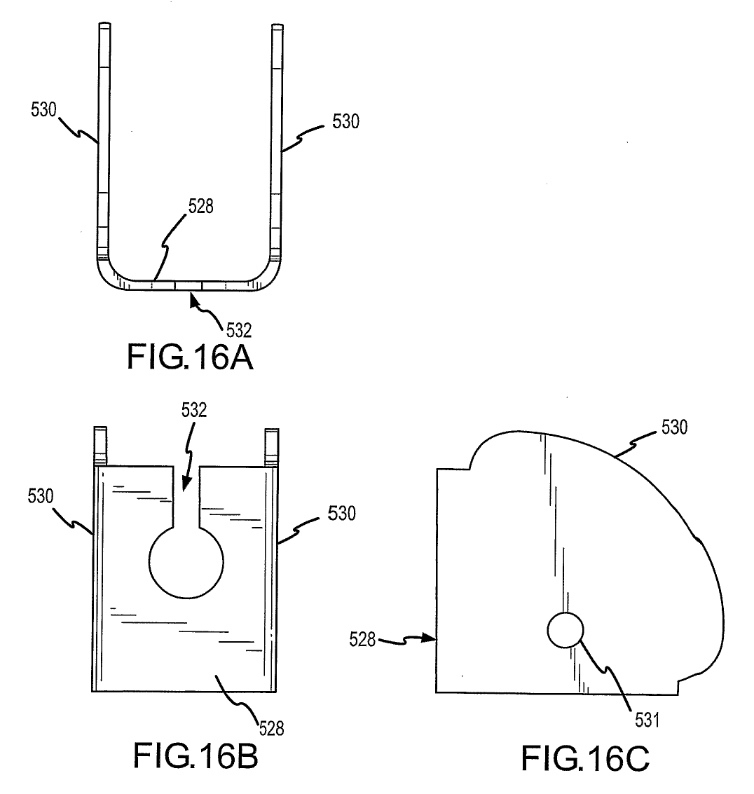

As depicted in greater detail in FIGS. 16A-16C, each of the hinge covers 524 has a flat end plate 528 normal to and sandwiched between two pie-shaped panels 530 covering an are of approximately 90°. The flat end plate 528 defines cable keyhole 532 for entry and exit of cabling within the extension arm 522. The pie-shaped panels 530 each define an aperture 531 through which the hinge covers 524 are attached to the extension arm 522.

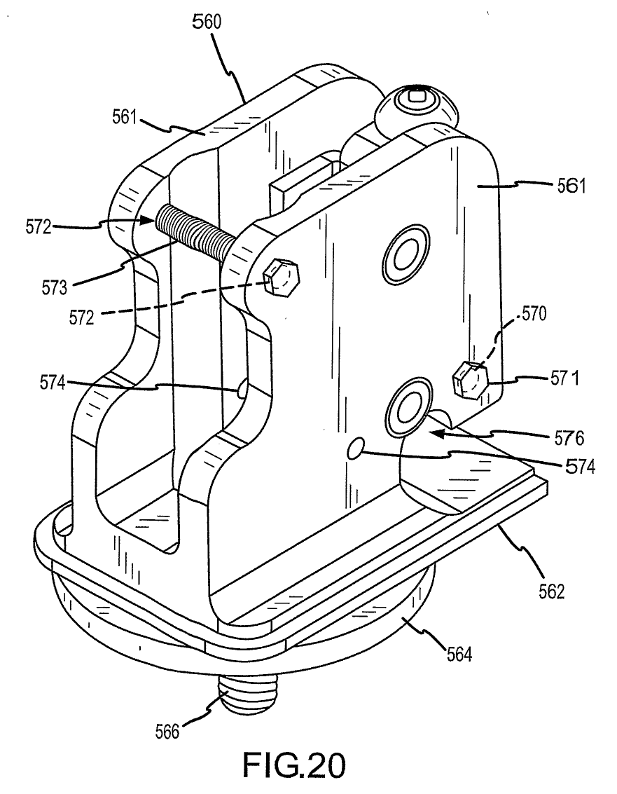

A hinge unit 560 as depicted in FIG. 20 is sandwiched between the pie-shaped panels 530 of the hinge cover 524. The bottom of the hinge unit 560 defines a hinge cap 562 which spans the area defined between the pie-shaped panels 530 of the hinge cover 524 and is oriented perpendicular to the rectangular end plate 528 of the hinge cover 528 defining the cable keyhole 532. The hinge unit 560 further has two vertical, parallel sidewalls 561 that extend upward from the hinge cap 563 and interface with the hinge cover 524. The sidewalls 561 define several apertures including a threaded screw hole 574 by which the hinge cover 534 is attached to the hinge unit 560 by set screws 565 passing through the apertures 531 in the hinge cover 534 (see FIG. 15). The sidewalls 561 each further define a first hinge aperture 570 through which is inserted a first hinge bolt 571 and a second hinge aperture 572 through which is inserted a second hinge bolt 573. A recess 576 is formed under one end of the sidewalls 561 adjacent the first hinge aperture 570 to provide clearance for an end of the extension arm 522 as it pivots on the first hinge bolt 571.

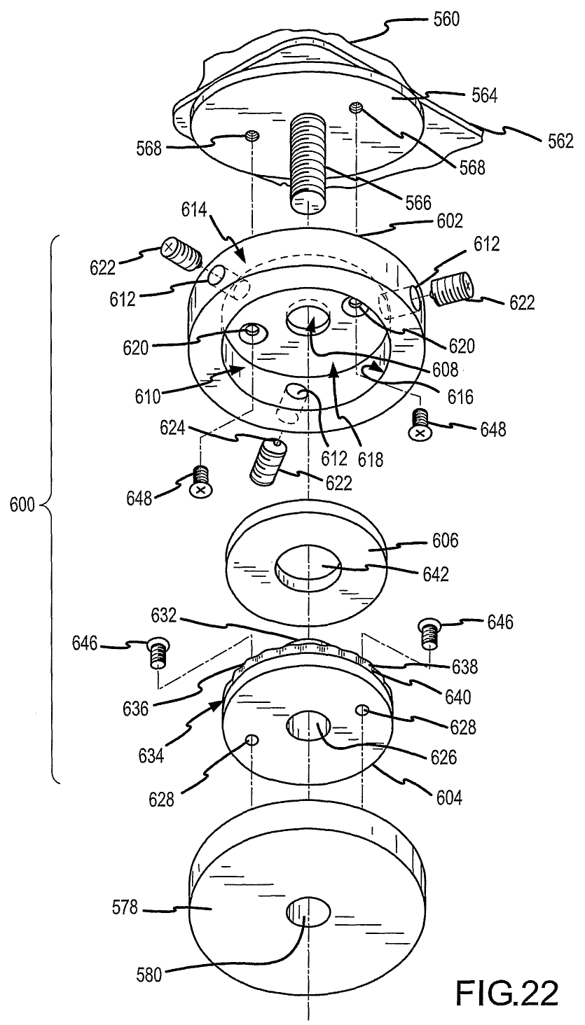

A disks-shaped hinge plate 564 is positioned beneath the hinge cap 562 to particularly interface with the nested index bearing 600. A threaded shoulder bolt 566 is fixed to the bottom face of the hinge plate 564 and functions as a connection member between the hinge joints 526 at the ends of the extension arm 522 and other members of the mounting system 500. The fixed bolt 566 also accommodates the nested index bearings 600 at the elbow joint 512 and the pivot joint 558. The bottom face of the hinge plate 564 also defines two set screw holes 568 (see FIG. 22) for fastening components of the nested index bearings 600 to the hinge units 560 as further described below.

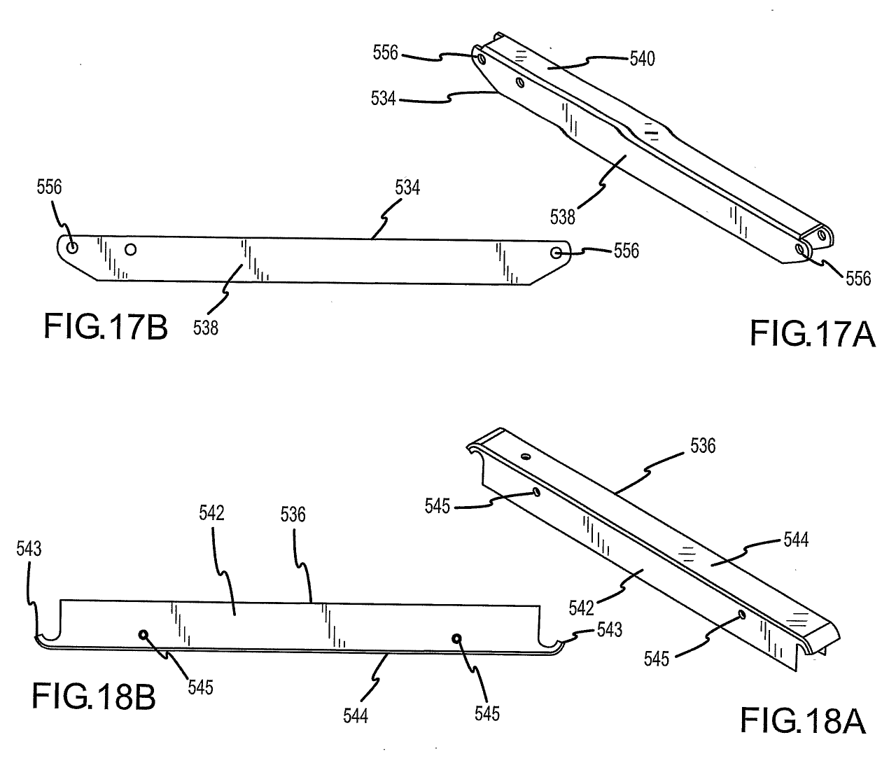

The extension arm 522 between the hinge covers 524 is comprised of a gas cylinder channel 534 as depicted in FIGS. 17A and 17B and a cable cover 536 as depicted in FIGS. 18A and 18B. As shown in FIG. 15, the gas cylinder channel 534 interfaces lengthwise with the cable cover 536 to form the outer shell of the extension arm 522. The gas cylinder channel 534 has two sidewalls 538 that extend normally from each side of a top panel section 540. The sidewalls 538 of the gas cylinder channel 534 also define hinge apertures 556 at each end. The second hinge bolt 573 in each of the hinge units 560 is placed through the hinge apertures 556 in the gas cylinder channel 534, thereby attaching the gas cylinder channel 534 to the hinge units 560.

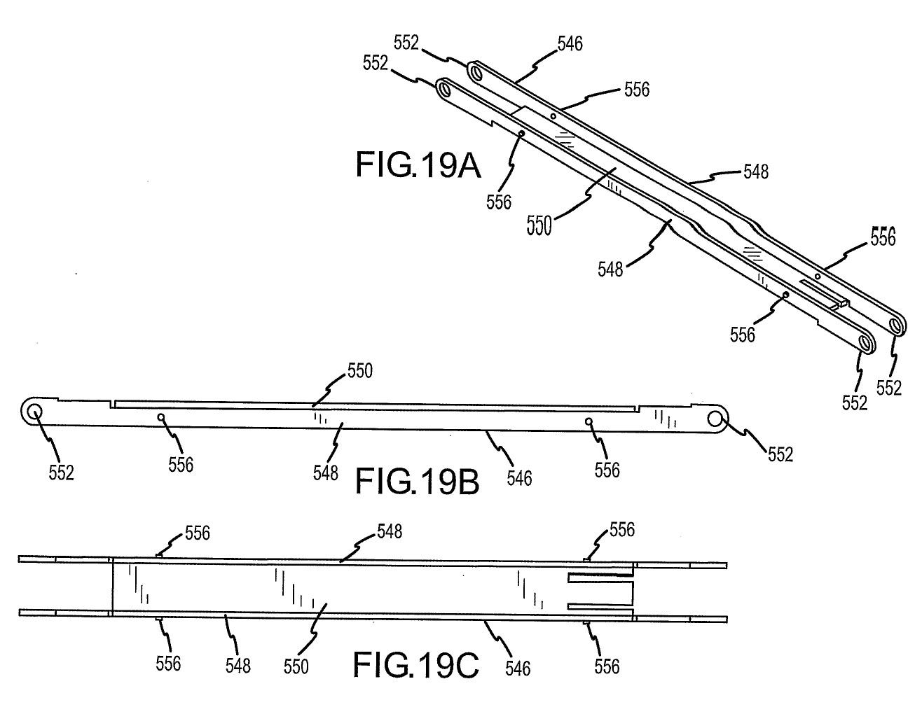

The cable cover 536 has two sidewalls 542 that extend normally from a base panel section 544. Each end 543 of the cable cover 536 is curved or hooked both by a cut-out of the sidewalls 542 and a bend in the base panel 544. The curved ends 543 provide clearance for the extension arm 522 as it pivots on the hinge unit 560. The curved ends 543 may extend under the recess 576 in the vertical sidewalls 561 of the hinge unit 560 as the extension arm 522 pivots. Each of the sidewalls 542 define two apertures 545 for attachment of the cable cover 536 to a pivot arm 546 (see FIGS. 19A-19C). The cable cover 536 covers the pivot arm 546, which is rotationally attached at each end to the hinge units 560.

The pivot arm 546 is composed of a pair of parallel pivot bars 548 separated by a separation panel 550 normal to the pivot bars 548 and attached along a lengthwise edge of each of the pivot bars 548. The ends of the pivot bars 548 define binge apertures 552 through which the first hinge bolt 571 is placed to attach the pivot arm 548 to the hinge units 560. The separation panel 550 is positioned within the open length of the cable cover 536 opposite the base panel 544 of the cable cover 536. Two retention pins 554 are defined in each of the pivot bars 548. The retention pins 554 interface with the apertures 545 in the sidewalls of the cable cover 536. The retention pins 554 may also accept screws inserted through the apertures in the sidewalls 542 of the cable cover 536 to fasten the cable cover 536 to the pivot arm 546.

Cable and cords threaded through the cable channel in the horizontal arm 504 are similarly threaded through the extension arm 522, entering the cable keyhole 532 in the hinge cover 524 adjacent the elbow joint 512, traveling through the cable 536 cover of the extension arm 522, and exiting the cable keyhole 532 of the hinge cover 524 adjacent a pivot joint 558. The cable cover 536 is easily removed from between the hinge covers 524 by removal of the screws fastening the sidewalls 542 of the cable cover 536 section to the retention pins 556 in the pivot bars 548 of the pivot arm 546 to aid in the threading of the cables or cords along the length of the extension arm 522.

The gas cylinder channel 534 houses a gas cylinder (not shown) that is connected between the hinge unit 562 adjacent the elbow joint 524 and the hinge unit 562 adjacent the pivot joint 558. The gas cylinder provides resistance against the angular movement of the extension arm 522 and holds the extension arm 522 in a static position when only acted upon by the force of gravity. Such gas cylinder configurations are well known in the art and are not described in detail herein. In this manner, the extension arm 522 may pivot on the hinge joints 526 within the hinge covers 524 and travel upward and downward with respect to the horizontal arm 504 creating a varying acute angle with respect to the horizontal arm 504 between 0° and 90°.

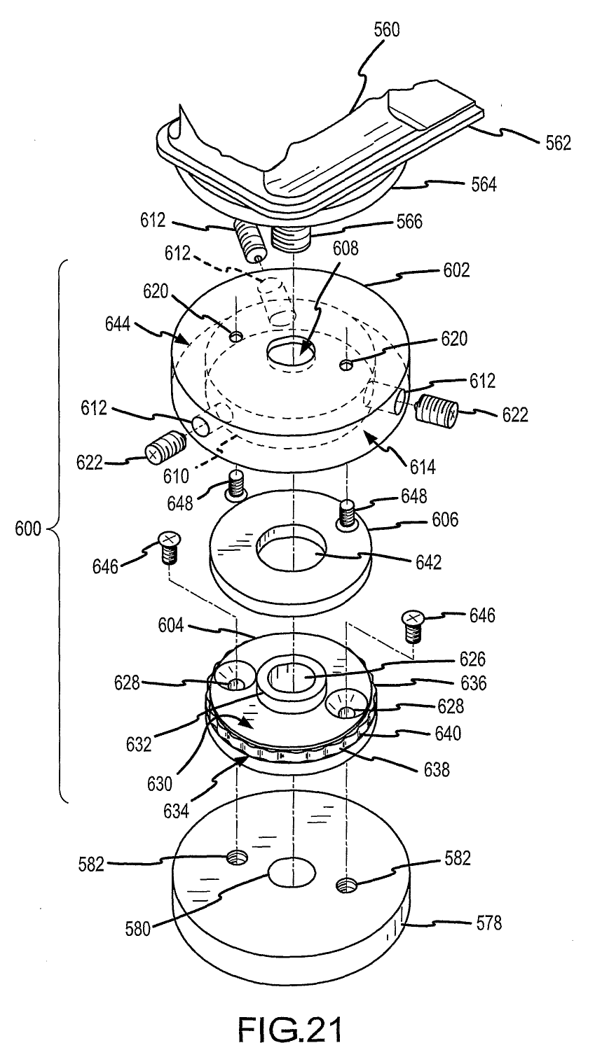

Each of the ceiling joint 506, the elbow joint 512, and the pivot joint 566 of the articulated ceiling mount system 500 of the present invention is formed by a nested index bearing 600. The nested index bearing 600 is primarily composed of three components as depicted in FIGS. 21 and 22. The nested index bearing 600 is formed of an outer bearing disk 602, an inner bearing disk 604, and a plate beating 606. The outer bearing disk 602 is composed of a disk with a large cylindrical recess 610 with a center through-hole 608 in the base wall of the cylindrical recess. The diameter of the cylindrical recess 610 extends significantly beyond the circumference of the center through-hole 608. The cylindrical recess 610 may be viewed as forming a flange 618 about the center through-hole 608. A pair of set screw apertures 620 are formed opposing each other within the flange 618 on opposite sides of the center through-hole 608.

Three threaded cartridge cavities 612 are bored radially through the sidewall 614 of the outer bearing disk 602 and exit about an inner cylindrical wall 616 forming the cylindrical recess 610. A spring plunger cartridge 622 is screwed into each of the cartridge cavities 612. The ball nose 624 at the end of each spring plunger cartridge 622 extends through the inner cylindrical wall 616 of the outer bearing disk 602 into the cylindrical recess 610 such that the ball nose 624 protrudes beyond the interior surface of the cylindrical wall 616 forming the cylindrical recess 610.

The inner bearing disk 604 may be formed with a center through-hole 626 and a pair of opposing set screw apertures 628 positioned on opposite sides of the center through-hole 626. The top surface 630 of the inner bearing disk 604 defines an inner disk rim 632 extending about the circumference of the center through-hole 626 and rising above the top surface 630 of the inner bearing disk 604 to form a protruding annular ring. The side wall 634 of the inner bearing disk 604 is formed with an undulating detent band 636. The detent band 636 is formed by an alternating series of peaks 638 and valleys 640, similar to a sinusoid.

The plate bearing 606 may be a millable plastic disk with a low coefficient of friction. A center through-hole 642 is formed in the plate bearing of a slightly larger diameter than the outside diameter of the inner disk rim 632 of the inner bearing disk 604. The outside diameter of the plate bearing 606 is slightly less than the diameter of the cylindrical recess 610 within the outer bearing disk 602.

In order to assemble the nested index joint 600, the plate bearing 606 is placed about the disk rim 632 of the inner bearing disk 604. Next both the inner bearing disk 604 and the plate bearing 606 are placed within the recess of the cylindrical recess 610 within the outer bearing disk 602. The rim disk 632 of the inner bearing disk 604 is of such a height that it extends through the center through-hole 608 of the outer bearing disk 602 to a height flush with the top surface 644 of the outer bearing disk 602. The ball noses 624 protruding from the cartridge cavities 612 in the outer bearing disk 602 interface with the peaks 638 and valleys 640 of the undulating detent band 636 on the side wall 634 of the inner bearing disk 604.

The ball noses 624 tend to lodge in a resting position in the valleys 640 of the detent band 636 and must be forced back against the springs in the spring plunger cartridges 622 in order to travel over a peak 638. Therefore, as the nested index joint 600 rotates, the rotational movement is indexed or stepped as the spring ball 624 protrudes into each valley 640 after being forced to travel over a peak 638. Through containment of the spring balls 624 in the valleys 640 of the detent band 636, the position of the horizontal arm 504, the extension arm 522, or the display mount linkage 700 of the articulated ceiling mount system 500 remains static unless placed under additional force to create rotational movement. The spring plunger cartridges 622 are chosen to be of sufficient force to counteract the force of gravity operating on the articulated ceiling mount system 500 to prevent rotational slippage in the members of the system.

Although, not depicted, the nested index bearing 600 may also have a rotation limitation structure as described with respect to the index bearing 118. For example, either the outer bearing disk 602 or the inner bearing, disk 604 may have an arcuate groove of limited arc length and the other bearing disk may have a pin that interfaces with the arcuate groove to limit the rotational travel of the nested index bearing 600.

As depicted in FIGS. 15, 21, and 22, the inner bearing disk 604 is affixed to a mounting surface via two set screws 646 positioned in its set screw apertures 628. Likewise, the outer bearing disk 602 is affixed to an opposing mounting surface. and fastened to the set screw holes 568 in the bearing plate 564 via two set screws 648 inserted through the two set screw apertures 620 in the outer bearing disk 602. The plate bearing 606 is situated between the inner bearing disk 604 and the outer bearing disk 602. A shoulder bolt is positioned within the center through-holes 608, 626, 642 of each of the inner bearing disk 604, the outer bearing disk 602, and the plate bearing 606 and is fastened against the opposing mounting surfaces.

In the articulated ceiling mount system 500 of FIG. 15, the nested index bearing 600 is affixed at the various joints in several different manners. At the ceiling joint 506, a shoulder bolt (not visible) is inserted through a bolt hole 517 in the bottom face 518 of the horizontal arm 504 at the proximal end 508. The shoulder bolt travels upward through the components of the nested index bearing 600 and exits into the center of the tube coupling 502. The shoulder bolt is fastened within the center of the tube coupling 502 by a lock nut. The outer bearing disk 602 may be affixed to the tube coupling 502 with the set screws 648. The inner bearing disk 604 may be affixed to the top surface of the horizontal arm 504 with the set screws 646.

The nested index bearing 600 is affixed at the elbow joint 512 between the distal end 510 of the horizontal arm 504 and the extension arm 522 in a slightly different manner. In this instance, a shoulder bolt is a fixed bolt 566 extending normally from the hinge plate 564 on the hinge unit 560. The hinge plate 564 has two set screw holes 568 for receiving the set screws 646 from the inner bearing disk 604. The outer bearing disk 602 is affixed to the bottom face of the horizontal arm 504 via the two set screws 648. The fixed shoulder bolt 566 extends upward through the nested index bearing 600 into the horizontal arm 504. The fixed shoulder bolt 566 is fastened against the horizontal arm 504 via a lock nut (not visible).

The nested index bearing 600 is mounted at the pivot joint 558 in a slightly different manner. In this instance, the outer bearing disk 602 is fastened to the hinge plate 564 of the hinge unit 560 via two set screws 648 while the inner bearing disk 604 is fastened to a base coupling piece 578. The base coupling 578 defines a center bore hole 580 flanked by two set screw holes 582. The inner bearing disk 604 is fastened to the base coupling 578 via two set screws 646 interfacing with the set screw holes 582. The fixed bolt 566 on the hinge plate 564 extends downwardly through the center through-holes 608, 626, 642 of the nested index bearing 600 and through the center borehole 580 in the base coupling 578. A pivot mount 702 in the display mount linkage 700 has a threaded bore hole (not visible) that interfaces with the fixed shoulder bolt 566 from the hinge plate 564. Thus the pivot mount 702 is screwed onto the downwardly extending fixed shoulder bolt 566 from the hinge plate 564 in order to secure the components of the pivot joint 558 in place.

Extending from the pivot joint 566 in the articulated ceiling mount system 500 is an exemplary display mount linkage 700 as depicted in FIG. 15. The display mount linkage has a pivot mount 702 attached to the base coupling 578 in the pivot joint 566. An angular adjustment bar 704 interconnects the pivot mount 702 to a fixed display mount 706 upon which is fastened a standard monitor mount 708. Handles 710 on the angular adjustment bar 704 provide leverage for and simplicity in loosing and tightening the hinges of the angular adjustment bar 704. It should be apparent that the display mount linkage 700 depicted in FIG. 15 can be replaced by the display mount linkage 200 disclosed herein with respect to FIGS. 1, 10, and 11.

Although various embodiments of this invention have been described above with a certain degree of particularity, or with reference to one or more individual embodiments, those skilled in the art could make numerous alterations to the disclosed embodiments without departing from the spirit or scope of this invention. It is intended that all matter contained in the above description and shown in the accompanying drawings shall be interpreted as illustrative only of particular embodiments and not limiting. All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the basic elements of the invention as defined in the following claims.

What is claimed is:

1. A rotational bearing comprising
an indexed bearing member comprising an array of detent structures and
a mounting surface that rotationally interfaces with the indexed bearing member and further comprises
an elastic retention structure supported by the mounting surface that interfaces with the array of detent structures.

2. The rotational bearing of claim 1 further comprising a bearing plate interposed between the indexed bearing member and the mounting surface.

3. The rotational bearing of claim 2, wherein the bearing plate defines an aperture through which the elastic retention structure interfaces with the array of detent structures.

4 The rotational bearing of claim 1, wherein
the indexed bearing member comprises a disk;
the array of detent structures comprises a plurality of recessed dimples defined in the surface of the disk arranged in a circle; and
the elastic retention structure comprises a spring plunger with a ball nose aligned to interface with the recessed dimples.

5. The rotational bearing of claim 1, wherein
the indexed bearing member further comprises a rotation limitation structure; and
the mounting surface further comprises an engagement member that interfaces with the rotation limitation structure to limit an arc of rotation of the rotational bearing.

6. The rotational bearing of claim 5, wherein
the indexed bearing comprises a disk;
the rotation limitation structure further comprises an arcuate groove defined in a surface of the disk; and
the engagement member comprises a pin extending from the mounting surface to interface with the arcuate groove.

7. The rotational bearing of claim 5 further comprising
a bearing plate interposed between the indexed bearing member and the mounting surface; and wherein
the indexed bearing comprises a disk;
the rotation limitation structure comprises an arcuate groove defined in a surface of the disk;
the array of detent structures comprises a plurality of recessed dimples in the surface of the disk arranged in a circle;
the engagement member comprises a pin extending from the mounting surface to interface with the arcuate groove;
the elastic retention structure comprises a spring plunger with a ball nose aligned to interface with the recessed dimples; and
the bearing plate defines a first aperture through which the pin extends and a second aperture through which the ball nose extends.

8. The rotational bearing of claim 7, wherein
the disk comprises a circular rim extending above the surface of the disk;
the bearing plate defines a central aperture about which the first aperture and second aperture are positioned; and
the central aperture of the bearing plate seats about the circular rim on the disk.

9. The rotational bearing of claim 1, wherein the mounting surface comprises a member of an articulated mounting system.

10. The rotational bearing of claim 1, wherein
the indexed bearing member comprises an inner disk with an outer sidewall of a first diameter;
the array of detent structures comprises an undulating surface of peaks and valleys circumscribing the outer sidewall;
the mounting surface comprises an outer disk which further defines
a cylindrical recess of a second diameter slightly larger than the first diameter of the inner disk; and
a radial aperture within an inner sidewall of the outer disk open to the cylindrical recess;
the elastic retention structure further comprises a spring plunger with a ball nose;
the spring plunger is housed within the radial aperture; and
the inner disk is positioned within the cylindrical recess of the outer disk such that the ball nose of the spring plunger engages the undulating surface.

11. The rotational bearing of claim 10 further comprising a bearing plate interposed between the inner disk and the outer disk.

12. The rotational bearing of claim 11, wherein
the inner disk further comprises a circular rim extending above a top surface of the inner disk; and
the bearing plate defines a central aperture that seats about the circular rim on the inner disk.

13. The rotational bearing of claim 10, wherein
the indexed bearing member further comprises a rotation limitation structure; and
the mounting surface further comprises an engagement member that interfaces with the rotation limitation structure to limit an arc of rotation of the rotational bearing.

14. The rotational bearing of claim 13, wherein
the rotation limitation structure further comprises an arcuate groove defined in a surface of the inner disk; and
the engagement member comprises a pin extending from a surface of the outer disk to interface with the arcuate groove.

15. The rotational bearing of claim 10, wherein
the mounting surface further comprises a rotation limitation structure; and
the indexed bearing member further comprises an engagement member that interfaces with the rotation limitation structure to limit an arc of rotation of the rotational bearing.

16. The rotational bearing of claim 15, wherein
the rotation limitation structure further comprises an arcuate groove defined in a surface of the outer disk; and
the engagement member comprises a pin extending from a surface of the inner disk to interface with the arcuate groove.

17. An articulated mounting system comprising
a first member;
a second member connected with the first member; and
the rotational bearing of claim 1 interposed at a joint between the first member and the second member.

18. The articulated mounting system of claim 17, wherein the mounting surface comprises the first member.

19. An articulated mounting system comprising
a first member;
a second member connected with the first member; and
the rotational bearing of claim 7 interposed at a joint between the first member and the second member.

20. The articulated mounting system of claim 19, wherein the mounting surface comprises the first member.

21. An articulated mounting system comprising
a first member;
a second member connected with the first member; and
the rotational bearing of claim 8 interposed at a joint between the first member and the second member.

22. The articulated mounting system of claim 21, wherein the mounting surface comprises the first member.

23. The articulated mounting system of claim 22, wherein
the disk further comprises a center aperture within the circular rim;
the first member comprises a first aperture;
the second member comprises a second aperture; and
the articulated mounting system further comprises
a bolt that passes through the first aperture of the first member, the second aperture of the second member, the center aperture of the disk, and the central aperture of the bearing plate, wherein the bolt holds the rotational bearing between the first member and the second member.

24. The articulated mounting system of claim 23, wherein
the disk further comprises an engagement aperture offset from the center aperture; and
the second member further comprises a pin offset from the second aperture and aligned to interface with the engagement aperture.

25. An articulated mounting system comprising
a first member;
a second member connected with the first member; and
the rotational bearing of claim 10 interposed at a joint between the first member and the second member.

26. An articulated mounting system comprising
a first member;
a second member connected with the first member; and
the rotational bearing of claim 11 interposed at a joint between the first member and the second member.

27. An articulated mounting system comprising
a first member;
a second member connected with the first member; and
the rotational bearing of claim 12 interposed at a joint between the first member and the second member.

28. The articulated mounting system of claim 27, wherein
the inner disk further comprises a first center aperture within the circular rim;
the outer disk comprises a second center aperture within a base wall of the cylindrical recess;
the first member comprises a first aperture;
the second member comprises a second aperture; and
the articulated mounting system further comprises
a bolt that passes through the first aperture of the first member, the second aperture of the second member, the first center aperture of the inner disk, the second center aperture of the outer disk, and the central aperture of the bearing plate, wherein the bolt holds the rotational bearing between the first member and the second member.

29. The articulated mounting system of claim 28, wherein
the circular rim of the inner disk further extends above the bearing plate and seats within the second center aperture in the outer disk.

30. An articulated mounting system comprising
a first member;
a second member connected with the first member; and
a bearing means interposed at a joint between the first member and the second member, wherein
the bearing means allows the first member to rotate about the joint with respect to the second member without loosening the joint; and
the bearing means resists the force of gravity on the articulated mounting system causing rotational drift of the first member about the joint without tightening the joint.

31. The articulated mounting system of claim 18, wherein the bearing means indexes the rotation of the first member in discrete steps about the joint.

32. A vertical mounting system for a display device comprising
a leveling plate adapted to attach to a ceiling;
an outer tube defining a bore attached to and extending downward from the leveling plate;
an inner tube of an outer diameter less than an inner diameter of the outer tube defined by the bore, wherein the inner tube slides within the bore of the outer tube; and
an attachment means for adjustably securing the inner tube at a fixed position within the outer tube.

33. The vertical mounting system of claim 32, wherein the leveling plate further comprises
a ceiling plate adapted to attach to the ceiling
at least three bolts fixed to the ceiling plate and extending vertically downward;
an offset plate positioned beneath and spaced apart from the ceiling plate and adapted to attach to the outer tube, wherein
the offset plate defines a plurality of apertures positioned opposite the bolts and each of the bolts passes through a corresponding one of the plurality of apertures;
a first set of nuts, each nut threaded on a respective one of the bolts and positioned on the bolts between the offset plate and the ceiling plate; and
a second set of nuts, each nut threaded on a respective one of the bolts and positioned on the bolts below the offset plate, wherein the second set of nuts tighten the offset plate against the first set of nuts.

34. The vertical mounting system of claim 33, wherein the offset plate defines a central aperture surrounded by the plurality of apertures and the central aperture is of a size that the inner tube may slide through the central aperture.

35. The vertical mounting system of claim 34 wherein the ceiling plate defines a tube aperture positioned opposite the central aperture in the offset plate and the tube aperture is of a size that the inner tube may slide through the tube aperture.

36. The vertical mounting system of claim 33, wherein
the offset plate further comprises a tubular coupling surrounding the central aperture and extending downward from a flat section of the offset plate;
an outer wall of the outer tube is threaded at a top end; and
an inner wall of the tubular coupling is threaded and sized to interface with the threaded outer wall of the outer tube.

37. The vertical mounting system of claim 32, wherein the outer tube defines an aperture in a sidewall for insertion of cabling of the display device into the bore.

38. The vertical mounting system of claim 32, wherein the inner tube defines an aperture in a sidewall for insertion of cabling of the display device into another bore defined by the inner tube.

39. The vertical mounting system of claim 32, wherein the attachment means comprises
a threaded aperture in a sidewall of the outer tube; and
a set screw secured in the threaded aperture that, when tightened, interfaces with a sidewall of the inner tube to secure the inner tube at a fixed position within the outer tube.

40. The vertical mounting system of claim 32, wherein the attachment means comprises
a first pair of threaded apertures in opposite halves of a sidewall of the outer tube; and
a first pair of set screws each secured in a respective one of the first pair of threaded apertures that, when tightened, interface with a sidewall of the inner tube to secure the inner tube at a fixed position within the outer tube.

41. The vertical mounting system of claim 40, wherein the attachment means further comprises
a second pair of threaded apertures in opposite halves of the sidewall of the outer tube and circumferentially offset from the first pair of threaded apertures; and
a second pair of set screws each secured in a respective one of the second pair of threaded apertures that, when tightened, interface with the sidewall of the inner tube to secure the inner tube at a fixed position within the outer tube.

42. The vertical mounting system of claim 41 wherein the second pair of threaded apertures is vertically offset from the first pair of apertures.

43. The vertical mounting system of claim 32, wherein the attachment means comprises
a first ring fixed to an outer circumference of the inner tube and positioned within the bore; and
a second ring fixed to an inner wall of the outer tube defining the bore, wherein the inner tube slides within an aperture defined by the second ring; and
the first ring interfaces with the second ring to prevent the inner tube from sliding out of a bottom opening of the inner tube.

44. The vertical mounting system of claim 43, wherein the attachment means further comprises
a pair of threaded apertures in opposite halves of a sidewall of the outer tube; and
a pair of set screws each secured in a respective one of the pair of threaded apertures that when tightened, interface with a sidewall of the inner tube to secure the inner tube at a fixed position within the outer tube; and wherein
the second ring is positioned above the pair of set screws.

45. The vertical mounting system of claim 32, wherein the inner tube further comprises a coupling structure for attaching the lower end of the inner tube to an additional mounting structure.

46. The vertical mounting system of claim 45, wherein the coupling structure comprises threading on an outer surface of the inner tube.

47. A mounting plate for supporting a display device in a mounting system, the mounting plate comprising
a mounting panel sized for attachment of a display device;
a first arm extending from a lateral side of the mounting panel a distance beyond a lateral edge of the display device;
a first handle connected with a distal end of the first arm.

48. The mounting plate of claim 47 further comprising
a second arm extending from an opposing lateral side of the mounting panel as the first arm a distance beyond an opposing lateral edge of the display device;
a second handle connected with a distal end of the second arm.

49. The mounting plate of claim 47, wherein
the first arm further comprises a bend that extends the distal end of the first arm in front of a first plane of the mounting panel; and
the first handle is positioned in front of a second plane of a display face of the display device.

50. The mounting plate of claim 48, wherein
the first arm further comprises a bend that extends the distal end of the first arm in front of a first plane of the mounting panel;
the first handle is positioned in front of a second plane of a display face of the display device;
the second arm further comprises a bend that extends the distal end of the second arm in front of the first plane of the mounting panel; and
the second handle is positioned in front of the second plane of the display face of the display device.

51. The mounting plate of claim 48 further comprising a disposable sterile covering over at least one of the first handle and the second handle.

52. The mounting plate of claim 47 further comprising one or more apertures for reception of a fastening member for attaching the mounting panel to a mounting system member.

53. The mounting plate of claim 47 further comprising one or more apertures for reception of a fastening member for attaching the display device to the mounting panel.

54. The mounting plate of claim 53 further comprising a set of four apertures arranged in a square of 75 mm per side.

55. The mounting plate of claim 53 further comprising a set of four apertures arranged in a square of 100 mm per side.

56. The mounting plate of claim 53 further comprising
a first set of four apertures arranged in a square of 75 mm per side; and
a second set of our apertures arranged in a square of 100 mm per side.
